(19) United States
(12) Patent Application Publication
(10) Pub. No.: US 2010/0116144 A1
(43) Pub. Date: May 13, 2010

(54) Foldable Brew Basket

(76) Inventors: Michael Safai, Louisville, KY (US); Medora Safai, Louisville, KY (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 12/266,796

(22) Filed: Nov. 7, 2008

(51) Int. Cl. A47J 31/08

(52) U.S. Cl. 99/298; 99/306

(57) ABSTRACT

A foldable brew basket has a rectangular bottom panel with an aperture through it, four side panels, and at least two rim panels. Two of the side panels are made of sub-panels with hingeable interconnections, while two of the side panels are flat. Like side panels are hingeably attached to opposite edges of the rectangular bottom panel and hingeably connected at their ends to unlike side panels. The rim panels are hingeably attached to the top edge of like side panels. In a usable configuration, the foldable brew basket has its sides approximately vertical with the rim panels approximately horizontal. In a folded configuration, the flat sides are folded toward the center of the bottom panel, while the side panels having sub-panels fold either inwardly or outwardly, flexing between the sub-panels. Some embodiments will also have a water permeable filter pouch containing brewing material.

### FIELD OF THE INVENTION

This invention relates generally to drip brewing of beverages. More specifically, this invention relates to a foldable disposable brew basket that is made from biodegradable materials.

### BACKGROUND OF THE INVENTION

A common method of brewing beverages, such as coffee and tea, is drip brewing. A drip brewer typically has a cold water reservoir, a heating element, a basket for holding brewing material, such as coffee grounds or tea leaves, a carafe for receiving brewed beverage, and a heating pad for keeping the beverage warm. The drip brewer heats the water from the cold water reservoir which passes up and drips into the brew basket which contains the brewing material for the particular beverage. The water then passes through the brewing material, through a filter, and out an aperture in the bottom of the brew basket to drip down into the carafe. A heating pad on which the carafe sets keeps the beverage warm after it is brewed. The drip brewing method of making beverages has been around for some time, and in more recent times drip brewed beverage makers have been provided in hotel and motel rooms. Their popularity ensures that these coffee makers will continue to be provided and those establishments that do not provide them at this time, will probably do so in the future. Typically, along with the drip brewer and brew basket, the brewing material is provided in filter pouches of water permeable material to allow the hot water to pass through the filter pouch and brew material before passing out through the aperture or apertures in the bottom of the brew basket. Frequently, the brew pouch is placed in the brew basket by a hotel guest when they wish to make coffee, tea, etc.

The cleaning provided by the housekeeping staff of hotels and motels is a major operation, and efficiency, for cost purposes, is of great importance. As a means of decreasing the time it takes to provide a fresh set up for the drip coffee makers, many hotels and motels have begun to use brew baskets that are disposable. These brew baskets mount into the coffee makers in the same way that reusable baskets do, but are made of less substantial material so that the cost is reduced and the brew basket is made to be disposed of. This relieves the housekeeping staff of the task of cleaning the brew baskets and replacing them in the hotel room for reuse. This is a substantial time savings, and therefore this is a substantial cost savings. Along with a desire for efficiency, there are concerns about sanitation when a brew basket is reused after a, perhaps, peremptory cleaning. As with many situations, concerns about sanitation leads to the use of disposable components, in this case the brew basket.

### DESCRIPTION OF THE PRIOR ART

A family of patents by Douglas A. Albrecht discloses and claims a brew basket that is disposable. This family of patents includes three utility patents which are U.S. Pat. No. 7,018,263, U.S. Pat. No. 7,258,884 and U.S. Pat. No. 7,311,037. In addition to these utility patents, there is the design patent by Douglas Albrecht numbered U.S. Pat. No. D560,430. Each of these patents disclose a brew basket and discusses several of the details of the brew basket including possible materials of which the brew basket may be made. One such material is high impact polystyrene. The brew baskets of the Albrecht patents are rigid and therefore take a significant amount of space when shipped and stored in bulk.

U.S. Pat. No. 4,867,993 by Nordskog is for a disposable and collapsible beverage brewing chamber for a brewing device. The beverage brewing basket of Nordskog has vertical sides which are collapsible in a generally vertical manor. This ability to collapse vertically is accomplished through two methods. One group of embodiments uses accordion-like pleats which allows the vertical sides to be expanded from a collapsed storage position for use. Another group of embodiment uses a sliding fit between two or more sections of the brew basket. The embodiments using the accordion-like pleats to obtain the vertically collapsible capability are made with a material sufficiently flexible and giving to allow the motion required. The embodiments using two or more sections in sliding relation to each other may be made with a less flexible material and still accomplish the collapsible effect. The embodiments with pleats in Nordskog require additional materials for the several pleats of the accordion like structure as well as a somewhat involved manufacturing process. The embodiments that use the several sections also require additional handling to join the several interconnected pieces. These requirements add cost to what is intended to be a disposable beverage brewing chamber.

U.S. Pat. No. 2,822,273 by J. T. Anderson is for a beverage maker meant to be set on top of a cup or other receptacle. The beverage maker has several folding panels folding up from a flat configuration to an open box-like configuration. Coffee grounds or other beverage brewing material is located in the bottom panel of the open box-like structure. This is set over a cup or other receptacle and liquid is poured into the box, the liquid drains through apertures in the bottom of the box, and the brewing beverage is then caught by the receptacle below. In its stored configuration, the open box of Anderson is folded inwardly and the various sections of the beverage maker are overlapped over the top of each other through the use of several creases and folds. The transition from a stored position to a useable position is accomplished by opening the beverage maker out flat and re-folding it through a series of complicated folds, including folding corners, etc.

U.S. Pat. No. 3,695,167 by Smitt et al. is for a filtering structure for coffee similar to that of Anderson in that it provides a container to be set on top of a receptacle. The container of Smitt has a bottom panel initially attached along one edge to a longer strip of panels with creases in them. This longer strip of panels is folded up and around the bottom panel of the structure and once created can be folded to an essentially flat configuration. When it is desired to be used, this box is opened up from this flat configuration and set atop a beverage receiving vessel. Hot water can then be poured through it in the presence of coffee grounds to brew coffee.

### SUMMARY OF THE INVENTION

An embodiment of the foldable brew basket has a rectangular bottom panel surrounded by 4 sides hingeably connected to the rectangular bottom panel, the surrounding sides also being hingeably interconnected with each other. Two of these side panels are flat while two others are made of sub-panels hingeably connected to each other. The flat side panels are on opposing edges of the rectangular bottom, while the folding side panels are also on opposing edges of the bottom panel. This leads to an alternation of flat side panels with folding side panels. The hingeably interconnected sub-panels of the folding side panels allow the folding side panels to fold to a different shape. This allows the flat side panels to be folded down over the rectangular bottom panel while the folding side panels either fold out away from the rectangular bottom panel, or inwardly against the bottom panel with the flat side panels ending up on top of the folded folding side panels. Along the top edges of at least one set of opposed side panels are located a rim panel on each side panel. These rim panels are suitable for allowing the foldable brew basket to be mounted into a drip brewing machine.

In an embodiment of the foldable brew basket, if these rim panels are hingeably attached to the folding side panels, then the rim panels will have sub-panels within them as well. These sub-panels in the rim panels may be as little as two or maybe more than that. This depends on which direction the rim panels are folded when the foldable brew basket is collapsed to a folded configuration. If the rim panels are lifted up as the brew basket is folded, then the rim panels may have two sub-panels, and if the rim panels are folded down as the brew basket is folded, then the rim panels may have three sub-panels. If an embodiment has rim panels on the flat side panels, these may be a single continuous rim panel not having any hinges or folds.

The ratio of the height of the side panels to the dimensions of the bottom panel will alter the folded configuration of the brew basket. If the side panels are approximately equal to half the width of the bottom panel, then when the foldable brew basket is folded, the flat side panels will meet approximately in the center of the bottom panel. If the height of the sides are greater than approximately half of the width of the bottom panel, then the side panels will meet somewhere above the bottom panel creating a space for any contents wished to be placed there. If the side panels have a height less than approximately half of the bottom panel, then they will not reach the middle of the bottom panel and the shape and configuration of the sub-panels of the folding side panels may be altered.

In some embodiments, brewing materials may be pre-located in the foldable brew basket when it is manufactured. This brewing material may be located in a water permeable filter pouch and placed in the foldable brew basket on the bottom panel. Other embodiments may be provided empty, allowing a user to add brewing material.

Some embodiments of the foldable brew basket will be packaged in an overwrap while other embodiments may be self sealed. In one embodiment, the overwrap might take the form of a sealed plastic sleeve. In the self sealing embodiments, pealable adhesive sealing strips may be placed over the apertures in the bottom panel of the embodiment, while a pealable adhesive strip may be placed over the top edges of the sides in the folded position. The pealable adhesive sealing strip could also be placed over and contact the rim panels in the folded position. Other embodiments may ensure full contact between rim panels and utilize adhesive between the rim panels to keep them sealed. Another embodiment may use a tear-away strip along the edge of the rim panels or top edge of the side panels to seal the folding brew basket. The tear-away strip would be removed along a line of perforations, crease, or other guide, to allow the foldable brew basket to be unfolded to an open configuration to be used for brewing.

Accordingly, those skilled in the art will appreciate that the conception upon which this invention is based may readily be utilized as a basis for the design of other structures, methods, and systems for carrying out the purposes of the present invention. It is important, therefore, that the claims be regarded as including such equivalent constructions insofar as they do not depart from the spirit of the present invention.

Furthermore, the purpose of the foregoing Abstract is to enable the U.S. Patent and Trademark Office and the public generally, and especially including the practitioners in the art who are not familiar with patent or legal terms or phraseology, to determine quickly from a cursory inspection, the nature and essence of the technical disclosure of the application. The Abstract is neither intended to define the invention of the application, nor is it intended to be limiting to the scope of the invention in any way.

### BRIEF DESCRIPTION OF THE DRAWINGS

Additional utility and features of the invention will become more fully apparent to those skilled in the art by reference to the following drawings, which illustrate the primary features of the several embodiments of the present invention.

FIG. 1 is a perspective view of the brewing basket unfolded into a useable configuration.

FIG. 2 is a perspective view of the brew basket of FIG. 1 collapsed down into a folded configuration.

FIG. 3 is another embodiment of a brew basket unfolded into a useable configuration.

FIG. 4 is a perspective view of the embodiment of FIG. 3 collapsed down into a folded configuration.

FIG. 5 is a perspective view of a brew basket having sides taller than one half the width of the bottom of the brew basket folded down into a folded configuration. The brew basket is sealed with a tear away perforated strip.

FIG. 6 is a perspective view of a brew basket having sides less than one half the width of the base folded down and partially unwrapped from a package.

FIG. 7 is a top view of a brew basket showing a permeable packet of brewable material located within the brew basket.

FIG. 8 is a side view of a brew basket having a sealable strip partially peeled from the aperture in the bottom of the brew basket,

FIG. 9 is a perspective view of a foldable brew basket folded nearly flat and sealed by a pealable adhesive strip with the pealable adhesive strip partially removed.

FIG. 10 is a perspective view of a foldable brew basket have one pair of side panels of greater height than the other pair of side panels.

### DETAILED DESCRIPTION OF THE PREFERRED EMBODIMENT

The detailed description below of certain embodiments is intended to explain the current invention. It is to be understood that a variety of other arrangements are also possible without departing from the spirit and scope of the invention.

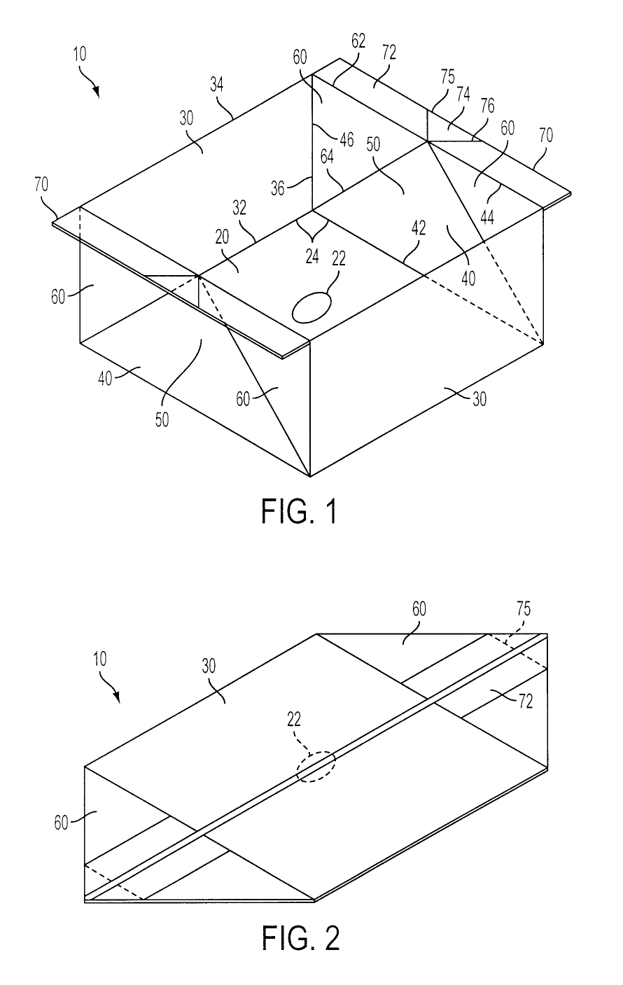

FIG. 1 shows an embodiment of a foldable brew basket 10 in a state ready to be used. The brew basket has a bottom panel 20 with an aperture 22 through it and four edges as shown at 24. Hingeably attached to bottom panel 20 of the foldable brew basket 10 are two opposing flat side panels 30. These flat side panels 30 each have a bottom edge 32, a top edge 34, and two side edges 36. The bottom edge 32 of each flat side panel 30 is hingeably attached to bottom panel 20 at edges 24. In addition to bottom panel 20 and the two opposed flat side panels 30, the embodiment shown in FIG. 1 has two opposing folding side panels 40.

These folding side panels 40 each have a bottom edge 42, a top edge 44, and two side edges 46, and are composed of hingeably interconnected sub-panels. These sub-panels include a central sub-panel 50 and two lateral sub-panels 60. The lateral sub-panels 60 are defined along one side by side edge 46 of folding side panel 40 and a portion 62 of top edge 44 of folding side panel 40. Lateral sub-panel 60 is further defined by a hingeable connection with central sub-panel 50 running from the previously two defined edges 62 and 46. Central sub-panel 50 takes up the balance of folding side panel 40 left by lateral sub-panels 60. In the embodiment shown in FIG. 1, the three sub-panels, central sub-panel 50 and lateral sub-panels 60, are hingeably connected triangular sub-panels.

In the embodiment shown in FIG. 1, two rim panels 70 are hingeably connected to folding side panels 40 along top edge 44 of folding side panel 40. Further, in the embodiment shown in FIG. 1, rim panels 70 are themselves segmented into three hingeably connected sub-panels, a central sub-panel 74 and two other sub-panels shown at 72 with hingeable interconnections 76. FIG. 2 shows the embodiment of FIG. 1 folded down flat wherein it can be seen that the height of flat side panels 30 are approximately half as high as the width of bottom panel 20 of the folding brew basket 10. The folded configuration shown in FIG. 2 results when flat side panels 30 are folded inwardly while central sub-panels 50 are folded outwardly and rim panels 70 are folded down in the initial step. This results in lateral sub-panels 60 being on the top while central sub-panel 50 is beneath. Rim panels 70 are partially on top of lateral sub-panels 60 with a small central portion, central sub-panel 74, beneath both lateral sub-panel 60 and central sub-panel 50. One edge of central sub-panel 74 of rim panel 70 may be seen along one edge 75, as a dashed line along the pointed end in FIG. 2.

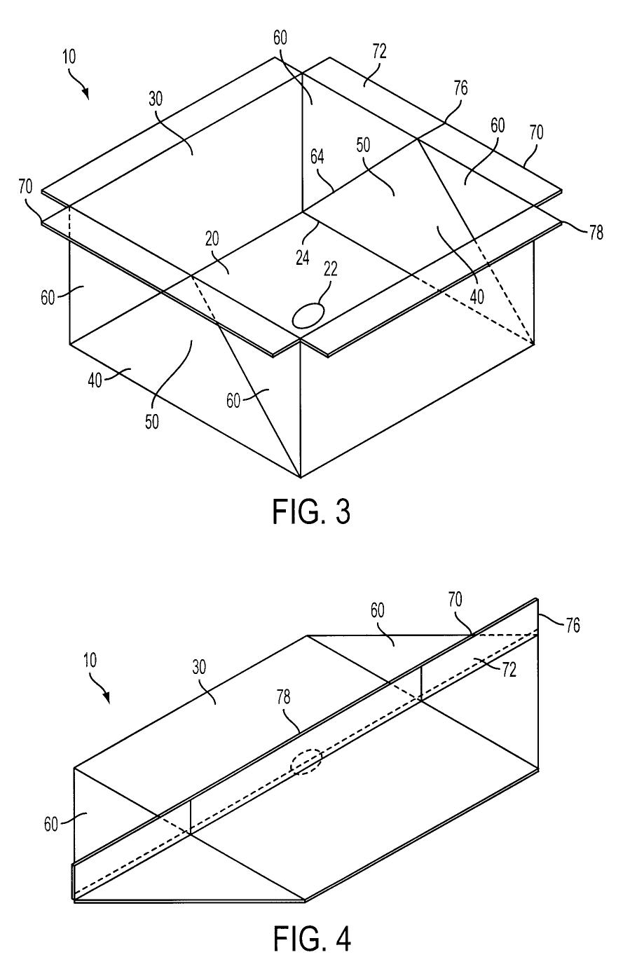

FIG. 3 shows an embodiment of the invention having additional rim panels 78 along the top edge 34 of flat side panels 30. Also, in this embodiment, rim panel 70 has a single hingeable interconnection 76 between its two sub-panels 72. FIG. 4 shows the embodiment of FIG. 3 folded down flat. In the configuration shown in FIG. 4, rim panels 70 were folded up as flat side panels 30 were folded toward the center of bottom panel 20. Hingeable interconnection 76 between sub-panels 72 of rim panel 70 becomes an end of the folded rim panel 70 while additional rim panels 78 are directed upward and rim panels 70 and 78 form a semi-continuous panel directed upward from the folded panels of the embodiment of FIGS. 3 and 4. Adhesive or other means can be used to seal the opening of folded brew basket 10. Alternatively, rim panels 70 can be folded down as flat side panels 30 are folded toward the center of bottom panel 20. This would result in two lines of rim panels running along the length of foldable brew basket 10 in its folded configuration. Again, in this embodiment flat side panels 30 have a height roughly equivalent to half the width of bottom panel 20. This results in a brew basket that may fold very flat.

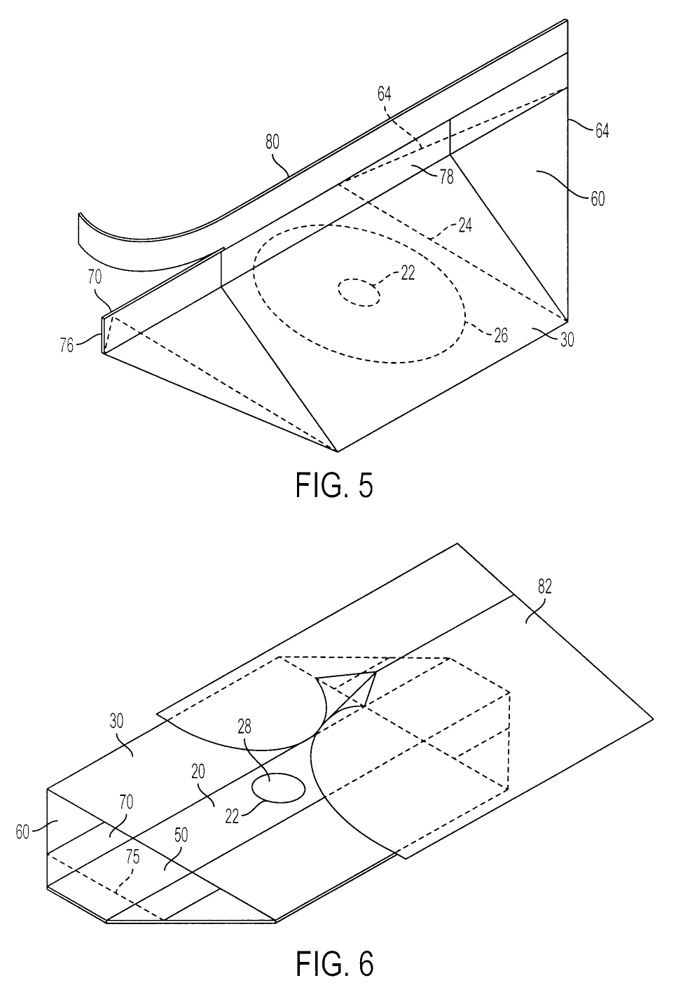

FIG. 5 shows an embodiment of the folding brew basket having rim panels attached around each of the side panels of the brew basket 10, but the sides of the brew basket 10 have a height greater than one half the width of bottom panel 20 of the folding brew basket 10. This results in a folding configuration where the flat side panels meet above the level of bottom panel 20 in a steeple configuration. Lateral sub-panels 60 align generally with flat side panels 30 in this folded configuration and rim panels 70 and 78 are directed upward forming two long panels with a slit between them. In this embodiment a tear away strip is shown attached to rim panels 70 and 78 to seal folding brew basket 10. As shown in FIG. 5, tear-away strip 80 is partially removed. When tear-away strip 80 is fully pulled away, folding brew basket may be opened up to a fully open position for use. Water permeable pouch 26 containing brewing material is shown within brew basket 10 in FIG. 5.

FIG. 6 shows an embodiment of the foldable brew basket 10 in its folded configuration and partially removed from a package 82. The foldable brew basket 10 is packed and shipped in package 82, with the package 82 removable when it is desired to use the foldable brew basket. The foldable brew basket 10 is unfolded and opened to a useable configuration when desired.

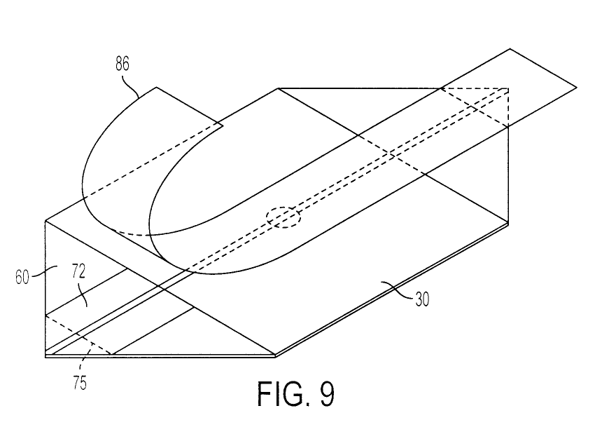

In the embodiment shown in FIG. 6 the height of the sides are less than approximately one half the width of bottom panel 20. Because of this, in its folded configuration, the flat side panels 30 do not reach all the way to the middle of bottom panel 20 when foldable brew basket 10 is in its collapsed or folded configuration. In addition, the central sub-panel 50 of folding side panel 40 is trapezoidal in shape. This can also be seen in FIG. 8 which is a side view of an embodiment in its useable configuration and having side panels less than half the width of bottom panel 20. The embodiment of FIG. 6 will also have changes in its folded configuration as far as where rim panel 70 is folded or hinged. Also shown in FIG. 6 is a water permeable cover 28 over aperture 22.

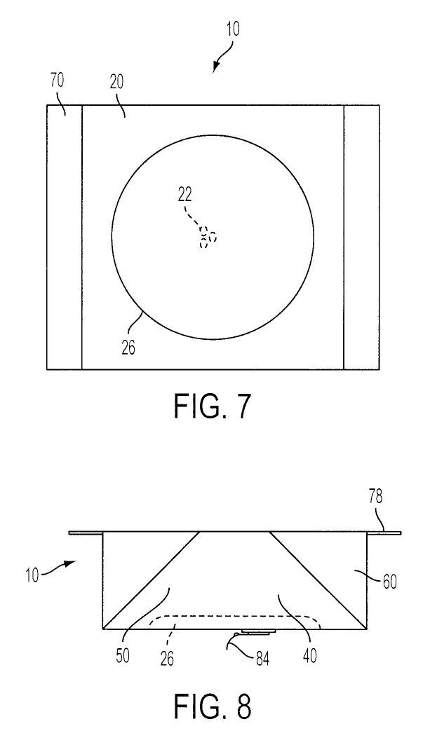

FIG. 7 is a top view of one embodiment of foldable brew basket 10. In it can be seen brew packet 26 which is made of water permeable material and contains brewing material for the brewed beverage. Beneath brew packet 26, shown in dotted lines, are multiple smaller apertures 22 allowing liquid to escape from the bottom of foldable brew basket 10.

FIG. 8 is a side view of one embodiment of the foldable brew basket 10. As mentioned previously, this embodiment has sides with heights less than half the dimension of bottom panel 20 of foldable brew basket 10. The view of FIG. 8 is shown from a side depicting folding side panel 40. It can be seen that the central sub-panel 50 of folding side panel 40 is trapezoidal as opposed to triangular. Lateral sub-panels 60 are still triangular. The shape and relationship of the side panels are not limited to those shown in the illustrations, but can be varied according to desired configurations. Along the bottom panel 20 in FIG. 8 pealable adhesive sealing strip is shown partially peeled away from bottom panel 20 of foldable brew basket 10. Pealable adhesive sealing strip 84 covers apertures 22 until foldable brew basket 10 is ready to be used, at which time pealable adhesive sealing strip is removed for use.

FIG. 9 shows a folded configuration of an embodiment of foldable brew basket 10. Pealable adhesive sealing strip 86 is also shown partially removed from the top side of foldable brew basket 10 in this folded configuration. Pealable adhesive sealing strip 86 seals the top of foldable brew basket 10 until it is ready to be used. At which time it may be removed and foldable brew basket 10 opened up to a useable configuration.

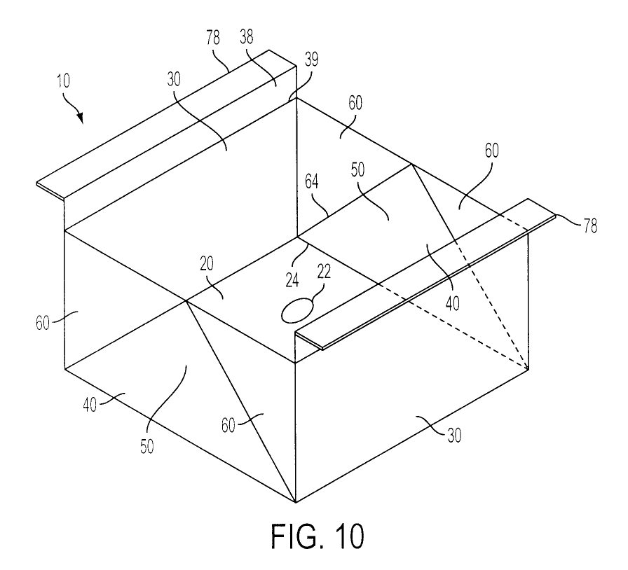

Referring to FIG. 10, another embodiment of foldable brew basket 10 is shown. As with other embodiments, foldable brew basket 10 of FIG. 10 has a pair of flat side panels 30 and a pair of folding side panels 40. In the embodiment of FIG. 10, flat side panels 30 have rim panels 78 attached to their top edges 34 and have a greater height than folding side panels 40. The area created by this greater height results in extension panel 38. Depending on the particular embodiment, extension panel 38 may remain essentially coplanar with the rest of flat side panel 30 when foldable brew basket 10 is placed in a folded configuration. Other embodiments may utilize a hingeable connection 39 between the main part of flat side panel 30 and extension panel 38. The use of hingeable connection 39 allows foldable brew basket 10 further folding options. For example, in an embodiment where flat side panels 30 are equal to or greater than one half of the width of bottom panel 20, extension panels 38 can fold out of the way when foldable brew basket 10 is in a folded configuration.

While the embodiment shown in FIG. 10 has flat side panels 30 that have greater height than folding side panels 40, the opposite relationship could also hold. Embodiments having folding side panels 40 of greater height than flat side panels 30 could also have rim panels 70 attached to their top edges 44 similar to the embodiments shown in FIGS. 1-4 and others. Again, a hingeable connection between the extension panel on the folding side panels of such an embodiment would allow additional folded configurations for foldable brew basket 10.

The foldable brew basket 10 is packaged, shipped and stored in a collapsed, or folded, configuration. Some embodiments may be shipped and stored within a package such as package 82 shown in FIG. 6. Some embodiments may be self-sealing such as the one shown in FIG. 5, wherein a tear-away strip along the edge of rim panels 70 and 78 seals the interior of foldable brew basket 10, or as in FIG. 4 where an adhesive sealant could be used between rim panels 70 and 78. The embodiment of FIG. 5 may also have a pealable sealing strip over aperture 22 as shown in FIG. 8 with pealable adhesive sealing strip 84. Other embodiments may have both their top and bottom sealed with pealable adhesive sealing strips such as shown at FIG. 9 with the pealable adhesive sealing strip 86 and pealable adhesive sealing strip 84 of FIG. 8.

To use a brew basket, a user would unseal the foldable brew basket 10 by either removing package 82, removing a tear-away strip 80, or removing pealable adhesive sealing strips 86 and 84. Once foldable brew basket 10 is unsealed, it may be opened out into a useable configuration having an interior space and rim panels. Some embodiments of foldable brew basket 10 may have a water permeable package 26 of brewing material already located within it. Other foldable brew baskets may be empty and the user will need to add coffee, tea or other brewing material. The brew basket may then be inserted into the brewing machine compatible with foldable brew basket 10.

Referring again to the embodiment shown FIG. 3 and FIG. 4, it is apparent that rim panels 70 and 78 are very similar and both sets of rim panels could function to support foldable brew basket 10 in a brewing machine. However, because material frequently has memory when it is moved from one configuration to another, folding side panels 40 have some tendency to spring outward providing more positive engagement of rim panels 70 with the brewing machine. Also, hingeable interconnections 76 between sub-panels 72 of rim panels 70 provide additional structural strength to rim panels 70.

Foldable brew basket 10 may be made of any material or combination of materials deemed suitable. It is expected that it will most usually be constructed overall from a material sufficiently flexible to allow the various hingeable interconnections to bend. However, other embodiments might use a more rigid material for the panels and sub-panels, while connecting the panels and sub-panels with flexible material for the hingeable interconnections. For embodiments explicitly intended to be disposable, biodegradable material may be used.

We claim:

1. A foldable brew basket for use with a brewing machine, said foldable brew basket comprising:
a rectangular bottom panel having at least one aperture therethrough and having a bottom side, a top side, and four edges;
an opposed pair of flat side panels, each of said flat side panels having a bottom edge, a top edge, and two side edges, said bottom edge of each said flat side panel being hingedly connected to an edge of said bottom panel opposite to that of the other flat side panel;
an opposed pair of folding side panels, each of said folding side panels having a bottom edge, a top edge and two side edges, said bottom edge of each said folding side panel being hingedly connected to an edge of said bottom panel opposite to that of the other folding side panel, and each said side edge of each said folding side panel being hingedly connected to a side edge of an adjoining flat side panel,
both said folding side panels each being divided into a central sub-panel and two lateral sub-panels,
each of said lateral sub-panels having one of said side edges of said folding side panels as a side, a portion of said top edge of the respective folding side panel as a side, and a third side connecting the previous two sides of each said lateral sub-panel, said third side of each said lateral sub-panel being hingedly connected to said central sub-panel of the respective folding side panel,
said central sub-panel of each said folding side panel being the balance of the respective folding side panel,
and at least two rim panels, a first of said at least two rim panels being hingedly connected to the top edge of either a flat side panel or a folding side panel and a second of said at least two rim panels being hingedly connected to the top edge of the side panel opposite to the one to which said first of said at least two rim panels is hingedly connected.

2. The foldable brew basket for use with a brewing machine of claim 1, wherein:
the height of said flat side panels is less than half of the length of the edges of said bottom panel to which said folding side panels are hingedly connected.

3. The foldable brew basket for use with a brewing machine of claim 1, wherein:
the height of said flat side panels is approximately the same as half of the length of the edges of said bottom panel to which said folding side panels are hingedly connected.

4. The foldable brew basket for use with a brewing machine of claim 1 wherein:
the height of said flat side panels is greater than half of the length of the edges of said bottom panel to which said folding side panels are hingedly connected.

5. The foldable brew basket for use with a brewing machine of claim 1 further comprising:
a water permeable filter pouch containing brewing material, said water permeable filter pouch being located on said top side of said rectangular bottom panel.

6. The foldable brew basket for use with a brewing machine of claim 1, wherein:
each said flat side panel and each said folding side panel has a rim panel hingedly attached to its top edge.

7. The foldable brew basket for use with a brewing machine of claim 1, wherein:
said foldable brew basket is made from a biodegradable material.

8. The foldable brew basket for use with a brewing machine of claim 1 further comprising:
a pealable bottom closure on said bottom side of said rectangular bottom panel over said at least one aperture in said bottom panel.

9. The foldable brew basket for use with a brewing machine of claim 1, wherein:
said foldable brew basket is contained in a sealed package.

10. The foldable brew basket for use with a brewing machine of claim 1, wherein:
in the folded configuration of said foldable brew basket, said top edges of said flat side panels and said folding side panels are temporarily sealed.

11. The foldable brew basket for use with a brewing machine of claim 10, wherein:
said top edges of said flat side panels and said folding side panels are temporarily sealed with adhesive.

12. The foldable brew basket for use with a brewing machine of claim 1 further comprising:
a pealable top closure temporarily sealing said top edges of said flat side panels and said folding side panels.

13. The foldable brew basket for use with a brewing machine of claim 12, wherein:
said pealable top closure is an adhesive strip.

14. The foldable brew basket for use with a brewing machine of claim 12, wherein:
said pealable top closure is initially attached to said top edges of said side panels or said rim panels and removable along a crease, perforations, or other guide.

15. The foldable brew basket for use with a brewing machine of claim 1, wherein:
one pair of side panels has greater height than the other pair of side panels.

16. The foldable brew basket for use with a brewing machine of claim 15, wherein:
one pair of side panels has greater height than the other pair of side panels.
